(19) United States
(12) Patent Application Publication
(10) Pub. No.: US 2024/0190079 A1
(43) Pub. Date: Jun. 13, 2024

(54) MODIFICATION OF COMPONENT PORTION MODELS FOR JOINING OF COMPONENT PORTIONS

(71) Applicant: Hewlett-Packard Development Company, L.P., Spring, TX (US)

(72) Inventors: Lluis PARE BARNIOL, Sant Cugat del Valles (ES); Oriol BORRELL CARBONELL, Sant Cugat del Valles (ES); Daniel Alejandro POVEDA PI, Sant Cugat del Valles (ES)

(21) Appl. No.: 18/286,121

(22) PCT Filed: Apr. 13, 2021
(86) PCT No.: PCT/US2021/027096

§ 371 Date: Oct. 7, 2023

(51) Int. Cl. B29C 64/386; B22F 5/00; B22F 10/80; B29L 31/00; B33Y 50/00; B33Y 80/00; G06T 19/20

(52) U.S. Cl. CPC B29C 64/386; B22F 5/007; B22F 10/80; B33Y 50/00; B33Y 80/00; G06T 19/20; B29L 2031/757; G06T 2219/2021

(57) ABSTRACT

According to examples, a computer-readable medium may have stored thereon instructions that may cause a processor to obtain a first 3D model of a first portion of a component, the first 3D model may include a first digital attachment edge corresponding to a first attachment edge on the first portion. The processor may obtain a second 3D model of a second portion of the component, the second 3D model may include a second digital attachment edge corresponding to a second attachment edge on the second portion, in which the second portion is to be joined with the first portion to form the component. The processor may modify the first 3D model to include a first digital rib including holes along a segment of the first digital attachment edge and the second 3D model to include a second digital rib including protrusions along a segment of the second attachment edge.

### BACKGROUND

Various types of products may be fabricated from a pulp of material. Particularly, a pulp molding die that includes a forming mold and a screen may be immersed in the pulp of material and the material in the pulp may form into the shape of the forming mold and the screen. The forming mold and the screen may have a desired shape of the product to be formed. The forming mold and the screen may include numerous pores for liquid passage, in which the pores in the screen may be significantly smaller than the pores in the forming mold. During formation of the product, a vacuum force may be applied through the pulp molding die which may cause some of the material in the pulp to be suctioned onto the screen and form into a shape that matches the shape of the pulp molding die. The material may be removed from the screen and may be solidified, for example through drying, to have the desired shape.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example computer-readable medium that may have stored thereon computer-readable instructions for modifying a first 3D model of a first portion of a component to include a first digital rib including holes and for modifying a second 3D model of a second portion of a component to include a second digital rib including protrusions;

FIG. 2 shows a diagram, which includes an example processor that may execute the computer-readable instructions stored on the example computer-readable medium depicted in FIG. 1;

FIGS. 3A and 3B, respectively, depict cross-sectional side views of an example forming tool and an example transfer tool;

FIG. 3C shows a cross-sectional side view of the example forming tool and the example transfer tool depicted in FIGS. 3A and 3B during a removal by the example transfer tool of the wet part from the example forming tool;

FIG. 3D shows an enlarged cross-sectional view of a section of the example transfer tool shown in FIG. 3B;

FIG. 4 shows depicts a perspective view of an example second portion that may be similar to the second portion depicted in FIG. 2;

FIGS. 5A-5E, respectively, show diagrams of an example mold onto which the example components depicted in FIGS. 1-3D may be mounted;

FIGS. 6A-6D, respectively, depict diagrams of example assemblies, e.g., molded fiber tools, in which ribs on sections of the example components depicted in FIGS. 1-3D may be mounted.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Three-dimensional (3D) fabrication systems may fabricate parts within respective build volumes. In some instances, such as when a part is larger than the build volume of a 3D fabrication system and/or an efficiency at which the part may be fabricated may be increased through splitting of the part into portions, the part may be fabricated into portions that may be joined together after the portions are fabricated. Disclosed herein are computer-readable media, methods, and apparatuses, in which a component may be fabricated as separate parts such that the parts may be fabricated with in a build volume of a 3D fabrication system while enabling the parts to be joined together securely after the parts are fabricated.

As discussed herein, a processor may modify a first 3D model of a first portion of a component to be fabricated by the 3D fabrication system to include a first digital rib. The processor may also modify a second 3D model of a second portion of the component to include a second digital rib. The first digital rib and the second digital rib may respectively be positioned along attachment edges of the first 3D model and the second 3D model. The first digital rib may include holes and the second digital rib may include protrusions that may be aligned with the holes when the first and second digital ribs are joined together.

The processor may modify the first and second 3D models to respectively include the first digital rib and the second digital rib such that the first and second portions of the component may be fabricated with respective ribs corresponding to the first digital rib and the second digital rib. The ribs with the holes and protrusions on the first portion and the second portion may facilitate secure attachment of the first portion to the second portion. That is, for instance, the ribs may provide surfaces along which the first portion and the second portion may securely be attached, especially when the first portion and the second portion have relatively thin profiles.

As discussed herein, the component may be a screen for a molded fiber tool and may thus have a relatively thin profile. For instance, the component may have a thickness that is less than 1 mm and in some cases, less than about 0.5 mm, although the component may have other thicknesses. The ribs may have heights that are greater than about 1.2 mm and in some cases, that are greater than about 1.5 mm, although the ribs may have other heights that are larger than the thickness of the component. As such, the ribs may provide a greater surface area over which the first and second components may be joined together.

As also discussed herein, the component, e.g., a screen for a molded fiber tool, may be mounted onto a mold of a molded fiber tool. In these examples, the mold may include a channel into which the ribs may be inserted when the component is mounted to the mold. The ribs may also have various cross-sectional configurations as discussed herein to enable the ribs to be joined to each other and/or to engage with a groove in the channel of the mold. In some examples, the component may be the mold of the molded fiber tool, such that the mold may be formed as multiple portions and joined together through any of multiple types of joining elements.

Through implementation of various features of the present disclosure, components, such as screens for molded fiber tools, may be fabricated as separate portions. The separate portions may be joined together securely through the ribs and the interconnection of the ribs with a channel in a mold. As a result, even though the components may have been fabricated as separate portions, the separate portions may be joined together to withstand the forces applied onto the components during molded fiber part production operations. This may also enable components that are larger than the build volumes of 3D fabrication systems to be fabricated by the 3D fabrication systems while being functional.

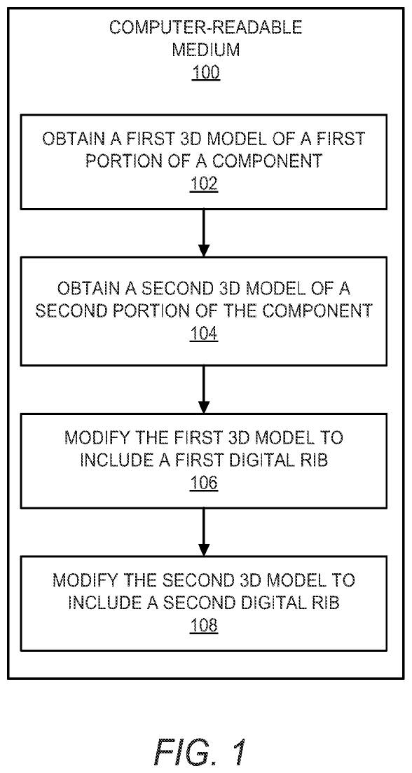

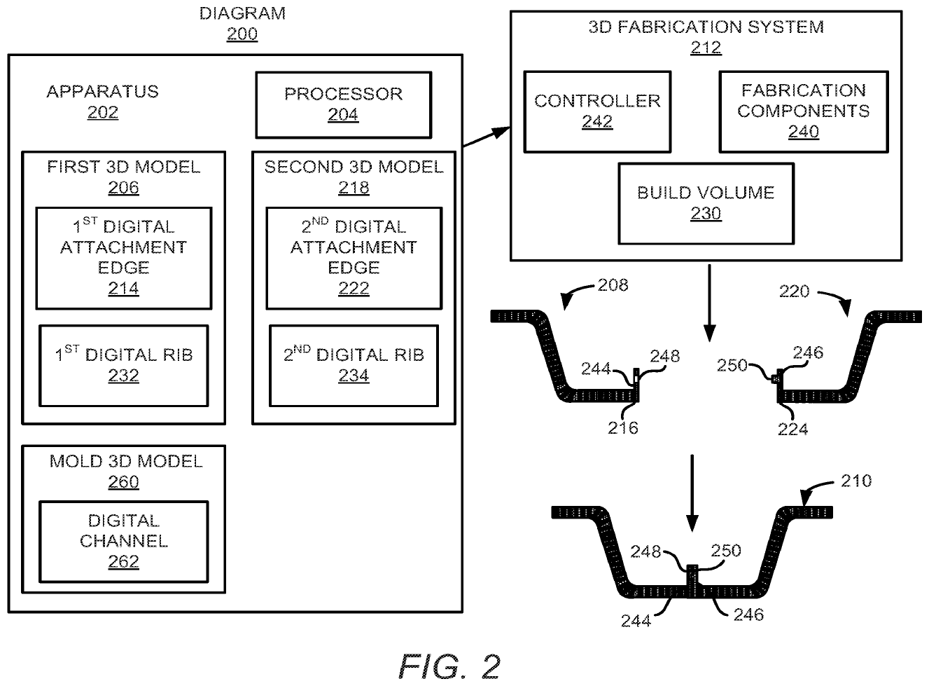

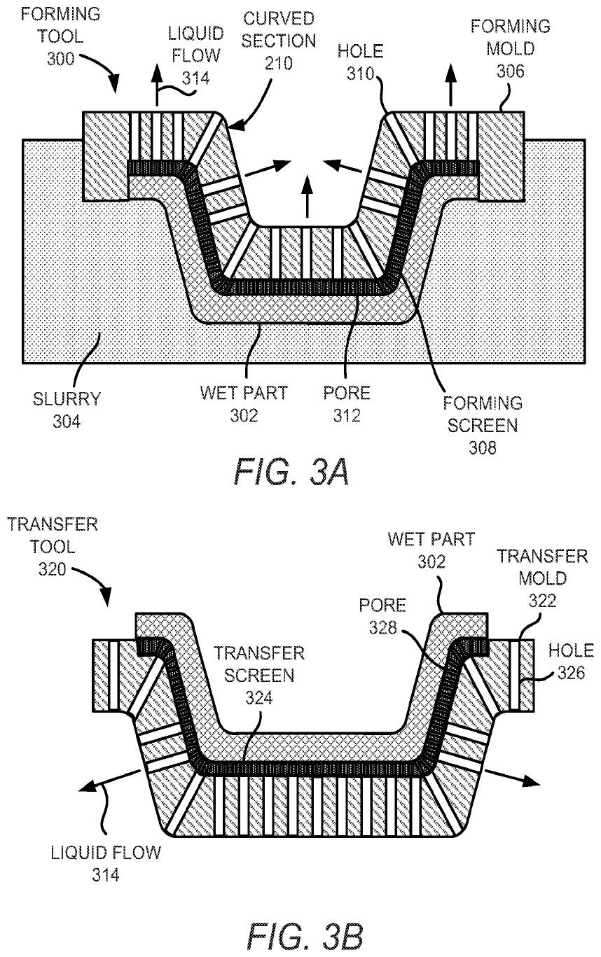

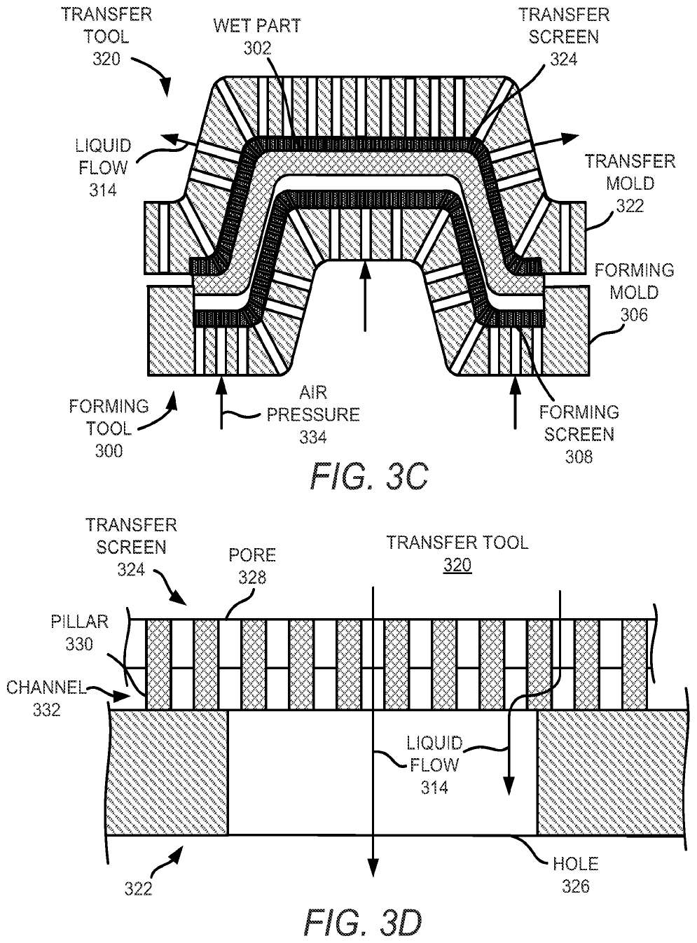

Reference is first made to FIGS. 1, 2, and 3A-3C. FIG. 1 shows a block diagram of an example computer-readable medium 100 that may have stored thereon computer-readable instructions for modifying a first 3D model 206 of a first portion 208 of a component 210 to include a first digital rib 232 including holes and for modifying a second 3D model 218 of a second portion 220 of the component 210 to include a second digital rib 234 including protrusions. FIG. 2 shows a diagram 200, which includes an example processor 204 that may execute the computer-readable instructions stored on the example computer-readable medium 100. FIGS. 3A and 3B, respectively, depict cross-sectional side views of an example forming tool 300 and an example transfer tool 320 and FIG. 3C shows a cross-sectional side view of the example forming tool 300 and the example transfer tool 320 during a removal by the example transfer tool 320 of a wet part 302 from the example forming tool 300.

It should be understood that the example computer-readable medium 100 depicted in FIG. 1, the example processor 204 depicted in FIG. 2, and/or the example forming tool 300 and the example transfer tool 320 respectively depicted in FIGS. 3A-3C may include additional attributes and that some of the attributes described herein may be removed and/or modified without departing from the scopes of the example computer-readable medium 100, the example processor 204, and/or the example forming tool 300 and the example transfer tool 320.

The computer-readable medium 100 may have stored thereon computer-readable instructions 102-108 that a processor, such as the processor 204 depicted in FIG. 2, may execute. The computer-readable medium 100 may be an electronic, magnetic, optical, or other physical storage device that contains or stores executable instructions. The computer-readable medium 100 may be, for example, Random Access memory (RAM), an Electrically Erasable Programmable Read-Only Memory (EEPROM), a storage device, an optical disc, and the like. Generally speaking, the computer-readable medium 100 may be a non-transitory computer-readable medium, in which the term “non-transitory” does not encompass transitory propagating signals.

The processor 204 may fetch, decode, and execute the instructions 102 to obtain a first 3D model 206 of a first portion 208 of a component 210 to be fabricated by a 3D fabrication system 212. The first 3D model 206 may include a first digital attachment edge 214 corresponding to a first attachment edge 216 on the first portion 208. The processor 204 may fetch, decode, and execute the instructions 104 to obtain a second 3D model 218 of a second portion 220 of the component 210. The second 3D model 218 may include a second digital attachment edge 224 corresponding to a second attachment edge 224 on the second portion 220. As shown in FIG. 2, the first attachment edge 216 and the second attachment edge 224 may be sections of the first portion 208 and the second portion 220 at which the first portion 208 and the second portion 220 are to be joined together. As discussed herein, the first portion 208 and the second portion 220 may be joined together along the first attachment edge 216 and the second attachment edge 224 to form the component 210.

The 3D fabrication system 212 may include a build volume 230, in which the build volume 230 may equivalently be termed a build bucket or the like. The build volume 230 may be the volume within which the 3D fabrication system 212 may fabricate parts and may define the maximum size that a part formed by the 3D fabrication system 212 may have. The build volume 230 may differ for different types of 3D fabrication systems 212. The 3D fabrication system 212 may also include fabrication components 240 and a controller 242 as discussed below.

The 3D fabrication system 212 may be any suitable type of additive manufacturing system. Examples of suitable additive manufacturing systems may include systems that may employ curable binder jetting onto build materials (e.g., thermally or UV curable binders), print agent jetting onto build materials (e.g., fusing agent and/or detailing agent), selective laser sintering, stereolithography, fused deposition modeling, etc. In a particular example, the 3D fabrication system 212 may fabricate the first portion 208 and the second portion 220 by binding and/or fusing build material particles together. In any of these examples, the build material particles may be any suitable type of material that may be employed in 3D fabrication processes, such as, a metal, a plastic (e.g., a nylon), a ceramic, a polymeric material, an alloy, and/or the like. In addition, the fabrication components 240 may be any suitable types of components, such as agent delivery devices, heat sources, laser beam sources, and/or the like that may fabricate parts from the build material particles.

In some instances, the component 210 may have a size that is larger than a dimension of the build volume 230. In these instances, the component 210 may be partitioned into the first portion 208 and the second portion 220, in which each of the first portion 208 and the second portion 220 may be sized to be fabricated within the build volume 230. The component 210 may be partitioned in any suitable manner, e.g., along a center line, along a line that meets predefined conditions, and/or the like.

The component 210 may be a component of a molded fiber toolset. As shown in FIGS. 3A-3C, the molded fiber toolset may include a forming tool 300 and a transfer tool 320. In addition, the forming tool 300 may include a forming mold 306 and a forming screen 308 and the transfer tool 320 may include a transfer mold 322 and a transfer screen 324. In some molded fiber toolsets, the transfer tool 320 may not include a transfer screen 324. The forming screen 308 may be mounted to the forming mold 306 directly and/or via an external support member (not shown). Likewise, the transfer screen 324, when included in the transfer tool 320, may be mounted to the transfer mold 322 directly and/or via an external support member (not shown). The component 210, which may also be referenced herein as a screen, may be any of the forming screen 308 and the transfer screen 324.

The first 3D model 206 and the second 3D model 218 may each be a computer aided design (CAD) file, or other digital representation of the respective first portion 208 and second portion 220, such as 3D manufacturing format (3MF) files, STL files, or the like. In addition, the processor 204 may obtain the first and second 3D models 206, 218 from a local data store (not shown) or from an external source, e.g., via the Internet. The processor 204 may also store the first and second 3D models 206, 218 in the local data store.

The processor 204 may fetch, decode, and execute the instructions 106 to modify the first 3D model 206 to include a first digital rib 232 along a segment of the first digital attachment edge 214 in which the first digital rib 232 may include holes. Although reference is made herein to holes, it should be understood that the holes may be other equivalent types of structures, such as sockets, pits, trenches, cavities, wells, depressions, and/or the like. The processor 204 may fetch, decode, and execute the instructions 108 to modify the second 3D model 218 to include a second digital rib 234 along a segment of the second digital attachment edge 224 in which the second digital rib 234 may include protrusions. Although reference is made herein to protrusions, it should be understood that the protrusions may be other equivalent types of structures, such as pins, projections, protuberances, and/or the like. The processor 204 may modify the first and second 3D models 206, 218 such that the first and second digital ribs 232, 234 have any suitable height for the intended purpose of the component 210. By way of particular example, the first and second digital ribs 232, 234 may have heights that may range between around 0.5 mm to about 2 mm. In any regard, the processor 204 may modify the first 3D model 206 and the second 3D model 218 by modifying the CAD file, the 3MF file, the STL file, and/or the like.

According to examples, the processor 204 may cause the 3D fabrication system 212 to fabricate the first portion 208 and the second portion 220 independently of each other. That is, the processor 204 may cause the 3D fabrication system 212 to fabricate both the first portion 208 and the second portion 220 during a common fabrication operation within the build volume 230. In other examples, the processor 204 may cause the 3D fabrication system 212 to fabricate the first portion 208 within the build volume 230 during a first fabrication operation and to fabricate the second portion 220 during a second fabrication operation, e.g., after the first portion 208 has been fabricated within the build volume 230.

In some examples, the processor 204 may convert the modified first 3D model 206 and the modified second 3D model 218 to be in a format that the 3D fabrication system 212 may use to fabricate the first portion 208 and the second portion 220. In some examples, the processor 204 may be part of or may otherwise control fabrication components 240 of the 3D fabrication system 212 to fabricate the first and second portions 208, 220. In other examples, the processor 204 may cause the 3D fabrication system 212 to fabricate the first and second portions 208, 220 by sending the first and second 3D models 206, 218 to the 3D fabrication system 212. In these examples, a controller 242 of the 3D fabrication system 212 may convert the 3D models 206, 218 into print ready files, such as by voxelizing the 3D models 206, 218, and may control the fabrication components 240 to fabricate the first and second portions 208, 220 based on the converted versions of the 3D models 206, 218. In some examples, the controller 242 may also slice the 3D models 206, 218 into slices that may correspond to layers in which the 3D fabrication system 212 may fabricate into the first and second portions 208, 220.

In some examples, the controller 242 may be equivalent to the processor 204 or may be a separate controller of the 3D fabrication system 212. The controller 242 may receive the first 3D model 206, which may include the first digital rib 232 including holes and may receive the second 3D model 218, which may include the second digital rib 234 including protrusions. The controller 242 may also control the fabrication components 240 to fabricate the first and second portions 208, 220 separately from each other within the build volume based on the received first and second 3D models 206, 218, in which the first and second portions 208, 220 of the component 210 may be attached to each other to form the component 210 following fabrication of the first and second portions 208, 220.

In any of the examples above, the 3D fabrication system 212 may fabricate the first portion 208 with a first rib 244 corresponding to the first digital rib 232 using the first 3D model 206 and the second portion 220 with a second rib 246 corresponding to the second digital rib 234 using the second 3D model 218. The 3D fabrication system 212 may fabricate the first portion 208 to include a hole 248 corresponding to the hole in the first digital rib 232. The 3D fabrication system 212 may also fabricate the second portion 220 to include a protrusion 250 corresponding to the pin in the second digital rib 234. As shown with respect to the component 210, the protrusion 250 may be aligned with the hole 248 and the protrusion 250 may be inserted into the hole 248 when the first portion 208 is joined with the second portion 220.

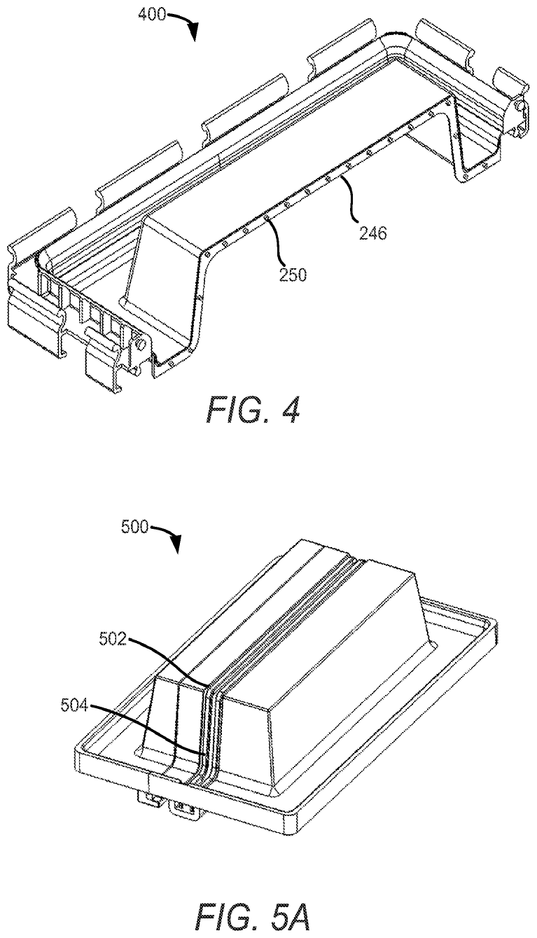

An example of the second portion 220 of the component 210 is depicted in FIG. 4. Particularly, FIG. 4 depicts a perspective view of an example second portion 400 that may be similar to the second portion 220 depicted in FIG. 2. As shown, the second portion 400 may include a second rib 246 that may extend continuously along a second attachment edge 224 of the second portion 400. Although not shown, the first portion 208 may have a similar configuration as the second portion 400. In addition, the first portion 208 may include the first rib 244, which may extend continuously along a first attachment edge 216 of the first portion 208 and may include holes 248.

The first rib 244 and the second rib 246 may each extend perpendicularly to the surfaces of the first portion 208 and the second portion 220. The first rib 244 and the second rib 246 may thus provide surfaces along which the first portion 208 and the second portion 220 may be joined together. As shown, the second rib 246 may include a plurality of protrusions 250. In addition, the first rib 244 may include a plurality of holes 248 into which the protrusions 250 may be inserted. As the surfaces of the first rib 244 and the second rib 246 may be larger than the surfaces at the first and second attachment edges 216, 224, the first rib 244 and the second rib 246 may enable the first and second portions 208, 220 to more securely be joined together.

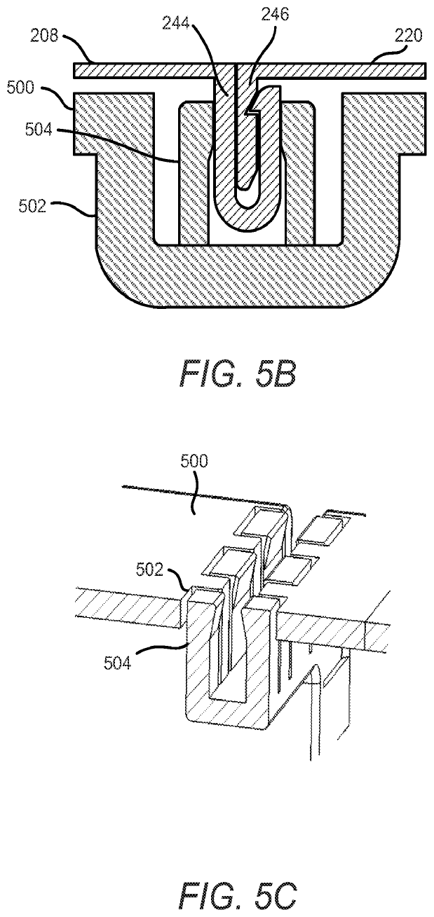

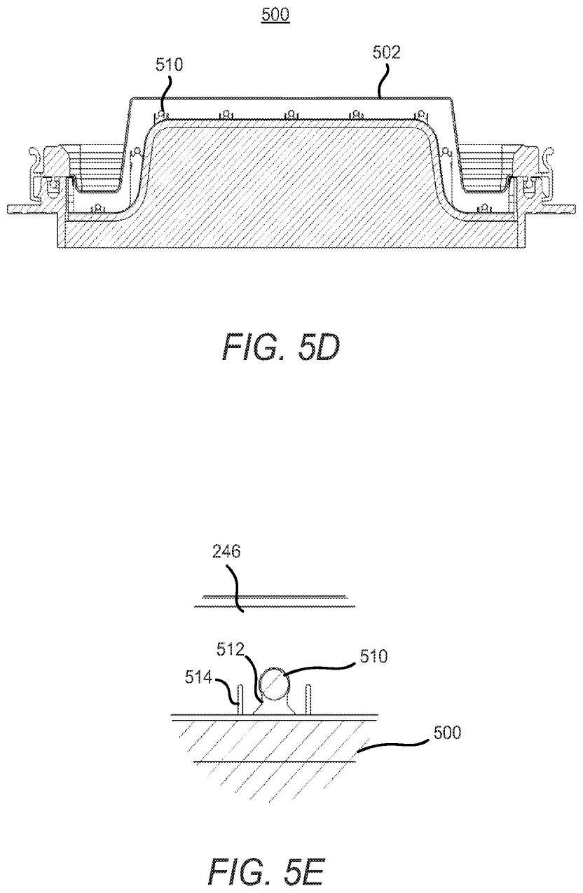

As discussed herein, the component 210 may be a screen of a molded fiber tool. The molded fiber tool may be a forming tool 300 and the component 210 may be a forming screen 308 as shown in FIG. 3A. Additionally, or alternatively, the molded fiber tool may be a transfer tool 320 and the component 210 may be a transfer screen 324 as shown in FIG. 3B. In these and other examples, the processor 204 may also obtain a 3D model 260 of a mold 500 (shown in FIG. 5A) of the molded fiber tool. In instances in which the molded fiber tool is a forming tool 300, the mold 500 may be a forming mold 306 and in instances in which the molded fiber tool is a transfer tool 320, the mold 500 may be a transfer mold 322.

According to examples, the processor 204 may modify the mold 3D model 260, e.g., the 3D model of the mold 500 of the molded fiber tool, to include a digital channel 262. The processor 204 may also cause the 3D fabrication system 212 to fabricate the mold 500, or another 3D fabrication system may fabricate the mold 500. In some examples, the controller 242 of the 3D fabrication system 212 may receive a 3D model 260 of a mold of the molded fiber tool, in which the 3D model 260 of the mold may include a digital channel 262. The controller 242 may also control the fabrication components 240 to fabricate the mold 500 with a channel 502 corresponding to the digital channel 262. As discussed herein, the first rib 244 and the second rib 246 of the screen 210 may be inserted into the channel 502 when the screen 210 is mounted on the mold 500. According to examples, the processor 204 may size the first and second ribs 244, 246 and the channel 502 such that the first and second ribs 244, 246 may securely be held in the channel 502 while maintaining a predefined spacing between the screen 210 and the mold 500.

As shown in FIG. 5A, which is a perspective view of the example mold 500, the mold 500 may have a complementary shape to the component 210 such that, for instance, the component 210 may be mounted on the mold 500. Examples of these arrangements are depicted in FIGS. 3A-3C. The mold 500 may include a channel 502 corresponding to the digital channel 262. In addition, as shown in FIGS. 5A and 5B, gripping members 504 may be provided within the channel 502. FIG. 5B also shows an example in which the first rib 244 and the second rib 246 are inserted into the gripping members 504. FIG. 5C shows an example of the gripping members 504 according to another example. Particularly, the gripping members 504 may include finger-like members.

According to examples, the processor 204 may modify the mold 3D model 260 to cause the digital channel 262 to include digital gripping members corresponding to the gripping members 504. The gripping members 504 may grip the first rib 244 and the second rib 246 when the first portion 208 and the second portion 220 are joined and mounted on the mold 500. In other words, the first rib 244 and the second rib 246 are to be inserted into the channel 502 on the mold 500 when the first portion 208 and the second portion 220 are joined and mounted on the mold 500.

According to other examples, and as shown in FIGS. 5D and 5E, the mold 500 may include other types of gripping members, e.g., cylindrical connection members 510 formed within the channel 502. In these examples, the first and second ribs 244, 246 may include matching connection slots 512 into which the connection members 510 may be inserted as shown in FIG. 5E. The connection slots 512 may be sized such that the openings into the connection slots 512 are slightly smaller than the connection member 510. As a result, the connection slots 512 may hold the connection members 510 in a manner than may prevent or otherwise hinder removal of the first and second ribs 244, 246 from the channel 502. To facilitate insertion of the connection members 510 into the connection slots 512, the first and second ribs 244, 246 may include slots 514 into which portions of the first and second ribs 244, 246 between the connection slots 512 and the slots 514 may extend during insertion and/or removal of the connection members 510.

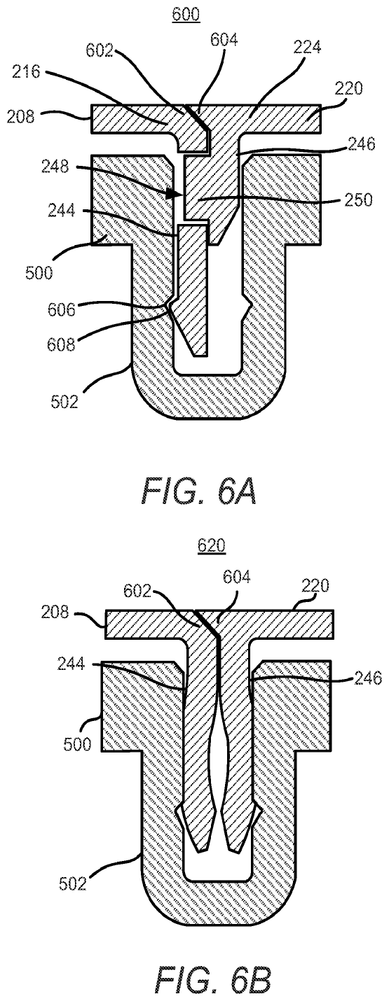

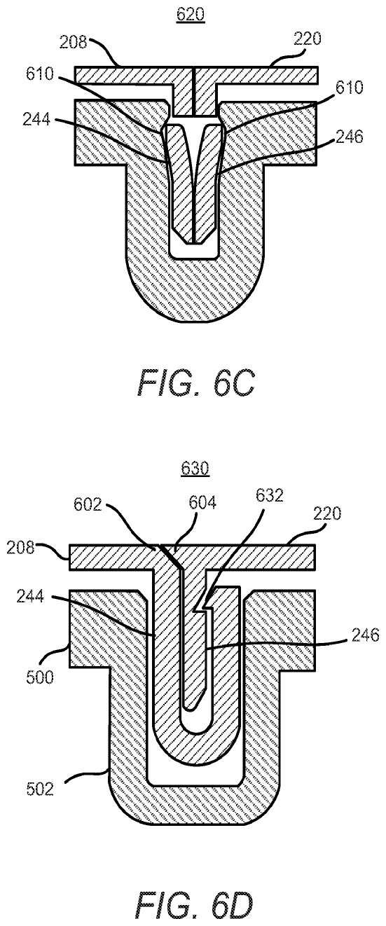

With reference now to FIG. 6A, there is shown a cross-sectional side view of an example assembly 600 of a first rib 244 of a first portion 208, a second rib 246 of a second portion 220, and a channel 502 of a mold 500. The assembly 600 shown in FIG. 6A may be an assembly of a molded fiber tool as discussed herein. In this regard, the molded fiber tool shown in FIG. 6A may include a first portion 208 of a component 210 of the molded fiber tool, in which the first portion 208 may include a first attachment edge 216. A first rib 244 may include holes 248 and may extend along a segment of the first attachment edge 216, in which the segment may include some or all of the first attachment edge 216.

The molded fiber tool (assembly 600) may also include a second portion 220 of the component 210, in which the second portion 220 may include a second attachment edge 224. A second rib 246 may extend along a segment of the second attachment edge 224, in which the segment may include some or all of the second attachment edge 224. The second rib 246 may include protrusions 250, in which the second portion 220 is to be joined with the first portion 208 through insertion of the protrusions 250 in the second rib 246 into the holes 248 in the first rib 244.

As shown in FIG. 6A, the first rib 244 may include a first chamfer 602 and the second rib 246 may include a second chamfer 604. The second chamfer 604 may be complementary to the first chamfer 602 in that the first and second chamfers 602, 604 may have complementary shapes with respect to each other. The processor 204 may modify the first 3D model 206 to include a digital version of the first chamfer 602 and may modify the second 3D model 218 to include a digital version of the second chamfer 604.

As also shown in FIG. 6A, the first rib 244 may have a first height and the second rib 246 may have a second height that is different from the first height. The first rib 244 may be relatively longer than the second rib 246 or vice versa. In addition, the processor 204 may modify the first 3D model 206 to cause the first digital rib 232 to have the first height and to modify the second 3D model 218 to cause the second digital rib 234 to have the second height.

FIG. 6A also shows an example of a protrusion 250 on the second rib 246 being inserted into a hole 248 in the first rib 244 to engage the first portion 208 with the second portion 220. The channel 502 in the mold 500 may also include a feature to removably retain the first and second ribs 244, 246 within the channel 502. Particularly, for instance, the channel 502 may include a groove 606 and the first rib 244 may include a tab 608, such that the tab 608 may be complementary to the groove 606. That is, the first rib 244 may be biased toward the groove 606 and the tab 608 may engage the groove 606 when the first rib 244 is fully inserted into the channel 502. The engagement between the tab 608 and the groove 606 may render separation of the first portion 208 and the second portion 220 from the channel 502 more difficult. The processor 204 may modify the first 3D model 206 to cause the first digital rib 232 to include the tab 608 and modify the 3D model 260 of the mold 500 to cause the digital channel 262 to include a groove 606.

Reference is now made to FIG. 6B, which shows a cross-sectional side view of an example assembly 620 of a first rib 244 of a first portion 208, a second rib 246 of a second portion 220, and a channel 502 of a mold 500. The assembly 620 may include some of the same features as the assembly 600 shown in FIG. 6A. However, the features of the first portion 208 and the second portion 220 in the assembly 620 may differ from the features of these portions in the assembly 600 depicted in FIG. 6A. Particularly, each of the first rib 244 and the second rib 246 may have a bowed shape. In this regard, resiliencies of the first rib 244 and the second rib 246 may enable the first rib 244 and the second rib 246 to be held within the channel 502. The processor 204 may modify the first 3D model 206 to cause the first digital rib 232 to have the bowed shaped and may modify the second 3D model 218 to cause the second digital rib 234 to have the bowed shape.

Turning now to FIG. 6C, a cross-sectional side view of the example assembly 620 shown in FIG. 6B according to another example is shown. Particularly, in FIG. 6C, the first rib 244 and the second rib 246 are depicted as being outwardly bowing at the tops of the first and second ribs 244, 246. The channel 502 is also shown as including grooves 610 into which the first and second ribs 244, 246 may be inserted.

Reference is now made to FIG. 6D, which shows a cross-sectional side view of an example assembly 630 of a first rib 244 of a first portion 208, a second rib 246 of a second portion 220, and a channel 502 of a mold 500. The assembly 630 may include some of the same features as the assembly 600 shown in FIG. 6A. However, the features of the first portion 208 and the second portion 220 in the assembly 630 may differ from the features of these portions in the assembly 600 depicted in FIG. 6A. Particularly, the first rib 244 may have a U-shaped cross section and the second rib 246 may be inserted within the first rib 244. In addition, the first rib 244 and the second rib 246 may include attachment features 632 that may interlock the second rib 246 and first rib 244 together. In examples in which the first portion 208 and the second portion 220 including linear attachment edges 216, 224, the first portion 208 and the second portion 220 may be engaged through linear movement of one of the first and second portions 208, 220 in a direction that is into or out of the page. In any regard, the processor 204 may modify the first 3D model 206 to cause the first digital rib 232 to have the U-shape and may modify the second 3D model 218 to cause the second digital rib 234 to have the attachment feature 632.

In some examples, and with reference back to FIG. 2, the processor 204 may be part of an apparatus 202, which may be a computing system such as a server, a laptop computer, a tablet computer, a desktop computer, or the like. In other examples, the processor 204 may be part of the 3D fabrication system 212. In either of these examples, the processor 204 may be a semiconductor-based microprocessor, a central processing unit (CPU), an application specific integrated circuit (ASIC), a field-programmable gate array (FPGA), and/or other suitable hardware device.

The apparatus 202 may also include a memory that may have stored thereon computer-readable instructions (which may also be termed computer-readable instructions) that the processor 204 may execute. The memory may be the computer-readable medium 100 depicted in FIG. 1. The memory may be an electronic, magnetic, optical, or other physical storage device that contains or stores executable instructions. The memory may be, for example, Random Access memory (RAM), an Electrically Erasable Programmable Read-Only Memory (EEPROM), a storage device, an optical disc, and the like. The memory, which may also be referred to as a computer-readable storage medium, may be a non-transitory computer-readable storage medium, where the term “non-transitory” does not encompass transitory propagating signals.

Particular reference is now made to FIGS. 3A-3C. FIG. 3A shows a cross-sectional side view of an example forming tool 300, in which a portion of the forming tool 300 has been depicted as being placed within a volume of a slurry 304 of a liquid and material elements. In some examples, the liquid may be water or another type of suitable liquid in which pulp material, e.g., paper, wood, fiber crops, bamboo, or the like, may be mixed into the slurry 304. The material elements may be, for instance, fibers of the pulp material. FIG. 3B shows a cross-sectional side view of the transfer tool 320 and FIG. 3C shows a cross-sectional side view of the forming tool 300 and the transfer tool 320 during transfer process by the transfer tool 320 of the wet part 302 from the forming tool 300. The forming tool 300 and the transfer tool 320 may collectively form a pulp molding tool set.

As shown in FIG. 3A, the forming tool 300 may include a forming mold 306 and a forming screen 308, in which the forming screen 308 may overlay the forming mold 306. As shown in FIG. 3B, the transfer tool 320 may include a transfer mold 322 and a transfer screen 324, while in some examples, the transfer tool 320 may not include the transfer screen 324. As discussed herein, some or all of the forming mold 306, forming screen 308, transfer mold 322, and the transfer screen 324 may be fabricated as separate portions 208, 222. FIGS. 3A and 3B depict the components 210 following attachment of the portions 208, 220.

In some examples, the forming mold 306 and/or the transfer mold 322 may be removably mounted onto respective supporting structures (not shown) such that, for instance, the forming mold 306 may be moved independently from the transfer mold 322. Moreover, the forming mold 306 and the forming screen 308 may be fabricated to have shapes to which the wet part 302 may be molded when formed on the forming screen 308. Likewise, the transfer mold 322 and the transfer screen 324 may be fabricated to have shapes that may engage multiple surfaces of the wet part 302 formed on the forming screen 308. The transfer screen 324 may have a shape that is complementary to the shape of the forming screen 308.

As also shown in FIGS. 3A-3C, the forming mold 306 and the transfer mold 322 may respectively include holes 310, 326 and the forming screen 308 and the transfer screen 324 may respectively include pores 312, 328 that may extend completely through respective top and bottom surfaces of the forming mold 306, the forming screen 308, the transfer mold 322, and the transfer screen 324. The pores 312, 328 may be significantly smaller than the holes 310, 326. In addition, a plurality of structural features, such as pillars 330 (shown in FIG. 3D) may be provided between the surfaces of the forming mold 306 and the forming screen 308 and between the transfer mold 322 and the transfer screen 324 that are respectively adjacent and face each other to enable liquid to flow laterally between the forming mold 306 and the forming screen 308 and between the transfer mold 322 and the transfer screen 324 as denoted by the arrow 314. As some of the pores 312 in the forming screen 308 may not directly align with the pores 312 in the forming mold 306 and some of the pores 328 in the transfer screen 324 may not directly align with the pores 328 in the transfer mold 322, the channels 332 formed by the structural features may enable liquid to flow through those pores 312, 328 in addition to the pores 312, 328 that are directly aligned with respective the holes 310, 326.

Although not shown, the forming tool 300 may be in communication with a plenum to which a vacuum source may be connected such that the vacuum source may apply a vacuum pressure through the holes 310 and the pores 312 in the forming mold 306 and the forming screen 308. When the vacuum pressure is applied through the holes 310 and the pores 312, some of the liquid in the slurry 304 may be suctioned through the holes 310 and the pores 312 and may flow into the plenum as denoted by the arrows 314. As the liquid flows through the holes 310 and the pores 312, the forming screen 308 may prevent the material elements in the slurry 304 from flowing through the pores 312. That is, the pores 312 may have sufficiently small dimensions, e.g., diameters or widths, that may enable the liquid to flow through the pores 312 while blocking the material elements from flowing through the pores 312. In one regard, the diameters or widths of the pores 312 may be sized based on sizes of the material elements, e.g., fibers, in the slurry 304. By way of particular example, the pores 312 may have diameters of around 0.6 mm. The pores 328 in the transfer screen 324 may also have similar diameters. However, in some instances, the pores 328 (as well as the pores 312) may have irregular shapes as may occur during 3D fabrication processes.

Over a period of time, which may be a relatively short period of time, e.g., about a few seconds, less than about a minute, less than about five minutes, or the like, the material elements may build up on the forming screen 308. Particularly, the material elements in the slurry 304 may be accumulated and compressed onto the forming screen 308 into the wet part 302. The wet part 302 may take the shape of the forming screen 308. In addition, the thickness and density of the wet part 302 may be affected by the types and/or sizes of the material elements in the slurry 304, the length of time that the vacuum pressure is applied while the forming mold 306 and the forming screen 308 are placed within the volume of the slurry 304, etc. That is, for instance, the longer that the vacuum pressure is applied while the forming mold 306 and the forming screen 308 are partially immersed in the slurry 304, the wet part 302 may be formed to have a greater thickness.

After a predefined period of time, e.g., after the wet part 302 having desired properties has been formed on the forming screen 308, the forming mold 306 and the forming screen 308 may be removed from the volume of slurry 304. For instance, the forming mold 306 may be mounted to a movable mechanism that may move away from the volume of slurry 304. In some examples, the movable mechanism may rotate with respect to the volume such that rotation of the movable mechanism may cause the forming mold 306 and the forming screen 308 to be removed from the volume of slurry 304. In other examples, the movable mechanism may be moved laterally with respect to the volume of slurry 304. As the forming mold 306 and the forming screen 308 are removed from the volume, some of the excess slurry 304 may come off of the wet part 302. However, the wet part 302 may have a relatively high concentration of liquid.

Following the formation of the wet part 302 on the forming screen 308 and movement of the forming screen 308 and the wet part 302 out of the volume of slurry 304, the transfer tool 320 may be moved such that the transfer screen 324 may contact the wet part 302 on the forming screen 308. That is, for instance, the transfer mold 322 may be attached to a movable mechanism (not shown), in which the movable mechanism may cause the transfer mold 306 and the transfer screen 324 to move toward the forming screen 308.

In addition, the transfer tool 320 may be in communication with a plenum to which a vacuum source may connected such that the vacuum source may apply a vacuum pressure through the holes 326 and the pores 328 while the wet part 302 is in contact with the transfer screen 324. The vacuum source may be the same or a different vacuum source to which the forming tool 300 may be in communication. Following the predefined length of time, the vacuum pressure applied through the forming tool 300 may be terminated or reversed (e.g., applied in the opposite direction) while vacuum pressure may be applied through the transfer tool 320 to facilitate transfer of the wet part 302 from the forming tool 300 to the transfer tool 320.

FIG. 3C shows a state in which the transfer tool 320 may be in the process of removing the wet part 302 from the forming screen 308. Particularly, in that figure, the transfer screen 324 has been moved into contact with the wet part 302 and a vacuum pressure has been applied onto the wet part 302 through the transfer screen 324. In addition, while the vacuum pressure is applied onto the wet part 302, the transfer tool 320 may be moved away from the forming tool 300 (or the forming tool 300 may be moved away from the transfer tool 320) to pull the wet part 302 off of the forming screen 308. To further facilitate removal of the wet part 302 from the forming screen 308, air pressure may be applied through the forming tool 300 as denoted by the arrows 334. As such, the wet part 302 may be biased toward the transfer tool 320 as opposed to being biased toward the forming tool 300. While the wet part 302 is biased toward the transfer tool 320, the transfer tool 320 may be moved away from the forming tool 300 such that the transfer tool 320 may remove the wet part 302 from the forming tool 300. In FIG. 3C, the forming tool 300 and the transfer tool 320 have been rotated 180º from their respective positions in FIGS. 3A and 3B. It should, however, be understood that the transfer mold 322 may remove the wet part 302 from the forming screen 308 while the forming tool 300 and the transfer tool 320 are in other orientations.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A non-transitory computer-readable medium on which is stored machine-readable instructions that when executed by a processor, cause the processor to:
obtain a first three-dimensional (3D) model of a first portion of a component to be fabricated by a 3D fabrication system, the first 3D model including a first digital attachment edge corresponding to a first attachment edge on the first portion;
obtain a second 3D model of a second portion of the component, the second 3D model including a second digital attachment edge corresponding to a second attachment edge on the second portion, wherein the second portion is to be joined with the first portion to form the component;
modify the first 3D model to include a first digital rib along a segment of the first digital attachment edge, the first digital rib including holes; and
modify the second 3D model to include a second digital rib along a segment of the second attachment edge, the second digital rib including protrusions that are to be aligned with the holes.

2. The non-transitory computer-readable medium of claim 1, wherein the instructions cause the processor to:
cause the 3D fabrication system to fabricate the first portion and the second portion independently of each other, wherein the 3D fabrication system is to fabricate the first portion with a first rib corresponding to the first digital rib using the first 3D model and the second portion with a second rib corresponding to the second digital rib using the second 3D model.

3. The non-transitory computer-readable medium of claim 1, wherein the instructions cause the processor to:
modify the first 3D model to cause the first digital rib to include a first chamfer; and
modify the second 3D model to cause the second digital rib to include a second chamfer, wherein the second chamfer is complementary to the first chamfer.

4. The non-transitory computer-readable medium of claim 1, wherein the instructions cause the processor to:
modify the first 3D model to cause the first digital rib to have a first height; and
modify the second 3D model to cause the second digital rib to have a second height, wherein the second height differs from the first height.

5. The non-transitory computer-readable medium of claim 1, wherein the instructions cause the processor to:
modify the first 3D model to cause the first digital rib to include a section having a U-shape, wherein the second rib corresponding to the second digital rib is to be inserted within the U-shape of a first rib corresponding to the first digital rib.

6. The non-transitory computer-readable medium of claim 1, wherein the component comprises a screen of a molded fiber tool, and wherein the instructions cause the processor to:
obtain a 3D model of a mold of the molded fiber tool; and
modify the 3D model of the molded fiber tool to include a digital channel, wherein a first rib corresponding to the first digital rib and a second rib corresponding to the second digital rib are to be inserted into a channel on the mold corresponding to the digital channel when the first portion and the second portion are joined and mounted on the mold.

7. The non-transitory computer-readable medium of claim 6, wherein the instructions cause the processor to:
modify the 3D model of the molded fiber tool to cause the digital channel to include digital gripping members, wherein gripping members in the mold corresponding to the digital gripping members are to grip the first rib and the second rib when the first portion and the second portion are joined and mounted on the mold.

8. The non-transitory computer-readable medium of claim 6, wherein the instructions cause the processor to:
modify the first 3D model to cause the first digital rib to include a tab; and
modify the 3D model of the mold to cause the digital channel to include a groove, wherein the groove is complementary to the tab.

9. The non-transitory computer-readable medium of claim 6, wherein the instructions cause the processor to:
modify the first 3D model to cause the first digital rib to have a bowed shaped; and
modify the second 3D model to cause the second digital rib to have the bowed shape.

10. A molded fiber tool comprising:
a first portion of a component of the molded fiber tool, the first portion including a first attachment edge;
a first rib extending along a segment of the first attachment edge, the first rib including holes;
a second portion of the component, the second portion including a second attachment edge; and
a second rib extending along a segment of the second attachment edge, the second rib having protrusions, wherein the second portion is to be joined with the first portion through insertion of the protrusions in the second rib into the holes in the first rib.

11. The molded fiber tool of claim 10, wherein the component comprises a screen in the molded fiber tool, the molded fiber tool further comprising:
a mold having a channel, wherein the first rib and the second rib are to be inserted into the channel, and wherein the channel includes a feature to removably retain the first rib and/or the second rib within the channel when the component is mounted on the molded fiber tool.

12. The molded fiber tool of claim 11, wherein the first rib and/or the second rib include a complementary feature to removably hold the first rib and the second rib within the channel.

13. A three-dimensional (3D) fabrication system comprising:
a build volume;
fabrication components; and
a controller to:
receive a first 3D model of a first portion of a screen of a molded fiber tool, the first 3D model including a first digital rib along a segment of the first 3D model, the first digital rib including sockets;
receive a second 3D model of a second portion of the screen, the second 3D model including a second digital rib including protrusions;
control the fabrication components to fabricate the first portion of the screen with a first rib corresponding to the first digital rib; and
control the fabrication components to fabricate the second portion of the screen with a second rib corresponding to the second digital rib, wherein the protrusions in the second rib are to be inserted into the sockets in the first rib to join the first portion and the second portion together to form the screen.

14. The 3D fabrication system of claim 13, wherein the controller is to:
receive a 3D model of a mold of the molded fiber tool, the 3D model of the mold including a digital channel; and
control the fabrication components to fabricate the mold with a channel corresponding to the digital channel, wherein the first rib and the second rib of the screen are to be inserted into the channel when the screen is mounted on the mold.

15. The 3D fabrication system of claim 13, wherein the screen comprises a size along a dimension that is larger than a dimension of a build volume of the 3D fabrication system and wherein the first portion and the second portion comprise sizes that are smaller than the dimension of the build volume of the 3D fabrication system.
